(19) United States
(12) Patent Application Publication
(10) Pub. No.: US 2008/0208523 A1
(43) Pub. Date: Aug. 28, 2008

(54) Method of determining geometric parameters of a wafer

(75) Inventors: Rene Schenck, Jena (DE); Ralf Friedrich, Giessen (DE); Thomas Iffland, Jena (DE); Daniel Skiera, Langgoens (DE)

Correspondence Address: Davidson, Davidson & Kappel, LLC, 485 7th Avenue, 14th Floor, New York, NY, 10018, US

(73) Assignee: VISTEC Semiconductor Systems GmbH, Weilburg (DE)

(21) Appl. No.: 12/072,196

(22) Filed: Feb. 25, 2008

(30) Foreign Application Priority Data
Feb. 28, 2007 (DE) DE10 2007010223.4

(51) Int. Cl. G01B 5/00

(52) U.S. Cl. 702/155

(57) ABSTRACT

A method of determining geometric parameters of a wafer (16) is disclosed. For this purpose, the wafer (16) is inserted in a wafer holder (30). The wafer holder (30) is equipped with at least three mechanical contacting elements (22). The wafer is in mechanical contact with the contacting elements (22). The contacting elements (22) are distributed on the wafer holder (30) in such a way that they define a geometric figure which is configured such that the center point (40) of the wafer (16) comes to lie within the geometric figure. The position of each contacting element (22) is determined. Each desired geometric parameter of the wafer (16) is then calculated from the position of the contacting elements (22).

This claims priority of German Patent Application No. 10 2007 010 223.4, filed on Feb. 28, 2007, the entire disclosure of which is hereby incorporated by reference herein.

The present invention refers to a method of determining geometric parameters of a wafer.

### BACKGROUND OF THE INVENTION

German patent application DE 10 2005 014 595 A1 discloses a method of visually inspecting an edge bead removal line on a disk-like object. Herein, an image of the edge zone of a disk-like object is first recorded. In the display of the recorded edge zone, the user can select a corresponding position with a marking element. The disk-like object placed on the stage is traversed with the stage in a corresponding manner, so that the position chosen by the user will be in the beam path of the microscope and can thus be displayed in a window on the display means in an enlarged condition. This is how the user is better able to choose or determine the edge bead removal line on the edge zone of the disk-like object in the enlarged display.

German patent application laid open publication DE 196 01 708 A1 discloses a method and system for determining a position on a surface of an object. The object can be a semiconductor wafer, for example, having on its surface a uniform arrangement of essentially vertical grid lines and a plurality of directional features. The method determines the direction of the grid lines relative to the direction of a reference coordinate system. A grid change associated with a change of direction for the plurality of directional features can also be determined. Herein, the position of the directional change is provided in the reference coordinate system. The apparatus also allows the center point to be determined with reference to the directional features of the distance of a feature from a geometric center point.

German patent specification DE 10 2004 032 933 B3 discloses a method for center point determination of adjustment markings having rotational symmetry. An image detection software is provided for determining the center point. The adjustment marking is detected in various alignments by the image detection software by rotating the adjustment marking about a symmetry angle with respect to which the adjustment marking has rotational symmetry, for each of which a reference point is determined. The point of rotation of the reference points determined corresponds to the center point of the adjustment marking. Further, a method for aligning two planar substrates is provided, each having an adjustment marking with rotational symmetry and essentially arranged in parallel to each other. For this purpose the center points of the adjustment markings of the two substrates are determined with the aid of the method for center point determination, and the two substrates are aligned by parallel displacement of at least one of the two substrates, so that the positions of the center points of the adjustment markings coincide.

### SUMMARY OF THE INVENTION

It is an object of the present invention to provide a method allowing the center point of the wafer to be determined unequivocally and irrespective of the form of the wafer edge.

The present invention provides a method comprising the steps of inserting the wafer in a wafer holder and then pressing the edge of the wafer against at least three mechanical contacting elements, wherein the at least three contacting elements are distributed in such a manner that a center point of the wafer is within a geometric form defined by the contacting elements. Finally, the method includes determining each position of each contacting element, and calculating the geometric parameters of the wafer from the positions of the contacting elements.

The invention has the advantage that it allows the center point of a wafer to be determined irrespective of the form of the wafer edge. To achieve this, first the wafer is inserted in a wafer holder. Herein, the edge of the wafer is pressed against at least three mechanical contacting elements, wherein the at least three contacting elements are distributed in such a way that a center point of the wafer is within a geometric form defined by the contacting elements. Then, each position of each contacting element is determined, and geometric parameters of the wafer are calculated from the position of the contacting elements.

The geometric parameters of a wafer can be, for example, its center point or the radius, or the diameter or the roundness of the wafer.

Each of the contacting elements can be formed as a pin, wherein the pin is provided with a marking or a bore. The position of each contacting element is determined via the marking or the bore from a bright-field or dark-field image.

It is particularly advantageous if at least one of the contacting elements is provided with a position encoder, so that it allows the position of each contacting element to be determined.

At least one mechanical sensor may be provided in addition to the at least three contacting elements, allowing the roundness of the wafer to be determined.

In a further embodiment, the edge of the wafer is mechanically contacted by four contacting elements. Herein, at least one of the four contacting elements is configured to be moveable, so that it allows the edge of the wafer to be pressed into contact with the other contacting elements.

The four contacting elements can be distributed about the edge of the wafer in such a way that the center point of the wafer comes to be positioned in a quadrangle defined by the contacting elements. The center point of the wafer is determined by the intersection of the mean perpendiculars of the sides of the quadrangle defined by the contacting elements.

In another advantageous embodiment of the invention, the edge of the wafer can be mechanically contacted by three contacting elements. Herein, at least one of the three contacting elements is configured to be moveable, so that it allows the edge of the wafer to be pressed into contact with the other contacting elements. The three contacting elements are distributed about the circumference of the wafer in such a way that they define a triangle and the center point of the wafer comes to lie within the triangle thus defined. The center point of the wafer is determined by the intersection of the mean perpendiculars of the triangle defined by the three positions of the contacting elements.

The contacting elements form a mechanical stop for the wafer edge so that the markings provided on the contacting elements have a defined distance to the edge of the wafer. It follows that the markings of the contacting elements also have a defined distance to the center point of the wafer. A distance vector is determined by the defined distance to the edge of the wafer, which can be set as a device-specific parameter.

The method allows the center point, the radius or the circumference of an unstructured wafer to be determined. The method also allows the center point, the radius or the circumference of the front surface of an unstructured wafer to be determined. The method also allows the center point, the radius or the circumference of the unstructured back surface of a structured or unstructured wafer to be determined. It is particularly advantageous if the method according to the present invention is used within an apparatus for optical inspection of a wafer. Herein, the apparatus can be structured in a plurality of modules, wherein at least one module comprises the optical inspection of the back surface of a wafer.

### BRIEF DESCRIPTION OF THE DRAWINGS

The invention will be described in the following in an exemplary manner and with reference to the accompanying drawings. From the accompanying drawings further features, objects and advantages of the present invention will be derived. In the drawings:

FIG. 1 is a schematic view of a system for optically inspecting wafers;

FIG. 2 is an enlarged view of the edge of the wafer;

FIG. 3 is a schematic view of an embodiment for determining the center point and other geometric parameters of a wafer;

FIG. 4 is a schematic view of a further embodiment for determining the center point and other geometric parameters of a wafer;

FIG. 5 is a schematic view of the scanning process of the surface of the wafer holder and therefore also the wafer;

FIG. 6 is a plan view of a contacting element having a marking, and its spatial arrangement with respect to the edge of the wafer; and

FIG. 7 is a plan view of a contacting element having a bore, and its spatial arrangement with respect to the edge of the wafer.

### DETAILED DESCRIPTION

In the drawings, identical reference numerals refer to identical or essentially equivalent elements or functional groups.

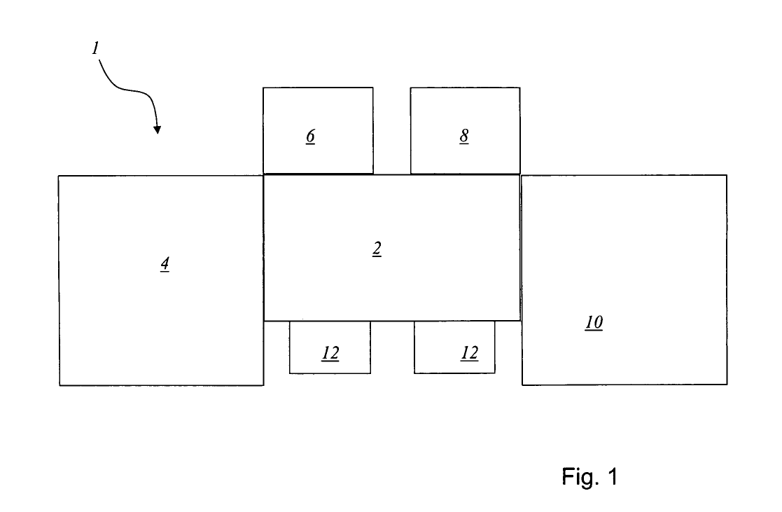

FIG. 1 shows a schematic view of a system 1 for optically inspecting wafers. System 1 has a modular structure. Modules 4, 6, 8 and 10 are arranged about a central unit 2 for carrying out various optical and/or non-optical inspections on the wafer. The central unit itself can carry out inspections on the wafer. Central unit 2 is essentially responsible for transferring the individual wafers to the various modules 2, 6, 8 and 10. Two load-ports 12 are also associated with central unit 2. The wafers to be inspected can be introduced into system 1 via load-ports 12. Modules 4, 6, 8 and 10 associated with central unit 2 can be provided for various optical and/or non-optical inspections on the wafer. Module 4, for example, can be provided for macro inspection of the wafer. Then, module 10 can be used for micro inspection. Herein, for example, positions on the wafer found by module 4 for macro inspection can be investigated and inspected more closely. Central unit 2 is also responsible for reciprocatively transferring the wafers between any of modules 4, 6, 8 and 10. Modules 6 and/or 8 associated with central unit 2 allow for an edge inspection and/or an inspection of the back surface of the wafer to be carried out. The method for determining the center point or the geometric parameters of a wafer can be incorporated in each of modules 4, 6, 8 and 10 present in FIG. 1.

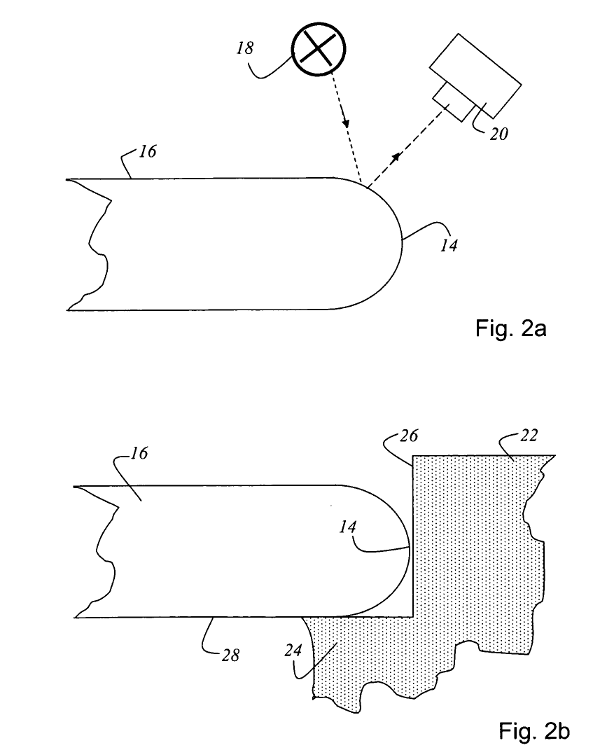

FIG. 2a is a schematic view of the edge 14 of a wafer 16. Edge 14 of wafer 16 is rounded. An angular or sharp-edge configuration of the edge of a wafer is not realizable. To determine the center point of wafer 16 it is therefore necessary that the position of edge 14 of wafer 16 is determined in a precise and unequivocal manner. From the position of edge 14 of the wafer, the center point or other geometric parameters of wafer 16 can be determined. If, as shown in FIG. 2, a purely optical detection of the position of the edge of the wafer is chosen in the bright field or dark field, an imprecise position of the wafer edge is obtained. If the edge 14 of wafer 16 is illuminated by a lamp 18, the light impinging on the wafer edge is reflected in various directions. The various reflections in various directions are due to the curved configuration of the wafer edge 14. This is how, when wafer edge 14 is imaged with a camera 20, a bright area is obtained, wherein precisely the optimum reflection condition is fulfilled. This bright area need not, however, coincide with the outer edge 14 of wafer 16. There is therefore a deviation between the actual wafer edge and the wafer edge detected by camera 20. This is why from a purely optical detection of edge 14 of wafer 16, the defined position of edge 14 of wafer 16 cannot be unequivocally determined.

FIG. 2b shows a contacting element 22, with which wafer 16 is mechanically held and contacted. Contacting element 22 has a support portion 24 and a stop surface 26. Wafer 16, with its edge 14, is in mechanical contact with stop surface 26 of contacting element 22. A support element 24, which is in contact with flat portion 28 of wafer 16, is arranged on contacting element 22 for supporting wafer 16.

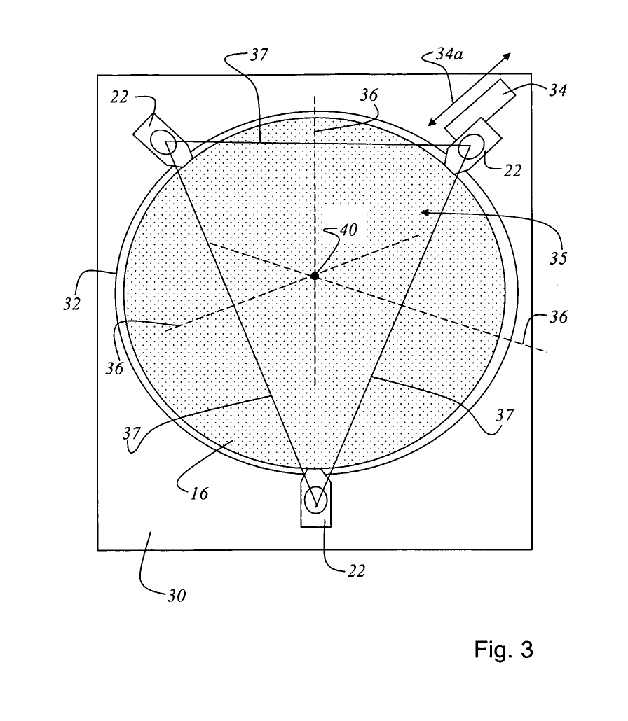

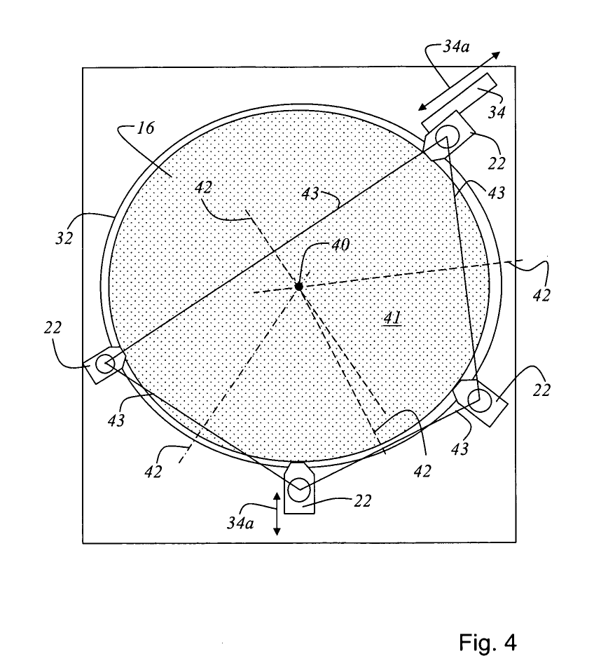

FIG. 3 is a schematic view of an embodiment for determining the center point or any other geometric parameter of a wafer 16. To determine the center point or other geometric parameters of wafer 16, the wafer is inserted in a wafer holder 30. Wafer holder 30 has a circular opening 32, which is slightly larger than wafer 16 itself. In the embodiment shown here, wafer holder 30 is equipped with three contacting elements 22. It goes without saying for a person skilled in the art that the number of contacting elements 22 shown here should not be construed as limiting the invention. It is also possible, as will be shown with respect to FIG. 4, to use more than three contacting elements. The wafer is inserted in opening 32 of wafer holder 30 in system 1 and is supported on support elements 24 of contacting element 22. To bring edge 14 (FIG. 2b) of the wafer into mechanical contact with contacting elements 22 or their stop surfaces 26 at least one contacting element is configured to be moveable. Contacting element 22 can be moved along a displacement direction 34. The displacement direction is shown as a double arrow 34a in FIG. 3a. Contacting element 22 allows edge 14 of wafer 16 to be brought into contact with the remaining contacting elements 22. This is how a defined distance of contacting elements 22 to edge 14 of wafer 16, and therefore also a defined distance of the contacting elements to center point 40 of wafer 16, is obtained from the position of contacting elements 22. Contacting elements 22 shown in FIG. 3 in contact with edge 14 of wafer 16 define a triangle 35. If more than three contacting elements 22 are provided for determining the center point 40 of wafer 60, these contacting elements 22 define a polygon in a corresponding manner. Contacting elements 22 are distributed around edge 14 of wafer 16 in such a way that the polygon defined by contacting elements 22 is configured such that center point 40 of wafer 16 is within the thus defined polygon. In the embodiment shown in FIG. 3, center point 40 is therefore within triangle 35 defined by contacting elements 22. Center point 40 of wafer 16 results from the intersection of mean perpendiculars 36 on the individual sides 37 of triangle 35 thus defined.

FIG. 4 is a further schematic view of a further embodiment for determining the center point or other geometric parameters of a wafer 16. Unlike the view of FIG. 3, in the view of FIG. 4 four contacting elements 22 are provided, which touch edge 14 of wafer 16 (See FIG. 2b). Herein, two of contacting elements 22 are configured to be moveable. Each contacting element 22 is moved along a displacement means 34 in the direction of double arrow 34a toward wafer 16 and therefore presses edge 14 of wafer 16 against the remaining fixed contacting elements 22. For mechanically contacting edge 14 of wafer 16 it is also conceivable to configure all contacting elements 22 as moveable. For precisely determining the position of contacting elements 22, these may be equipped with a position encoder. Not all contacting elements 22 need be configured as moveable. For position determination, or for determining the position of a contacting element 22, the latter may be provided with a position encoder. In the embodiment shown in FIG. 4, four contacting elements 22 are provided, which contact edge 14 of wafer 16. Contacting elements 22 are arranged around the edge of wafer 16 in such a way that their contacting points on edge 14 of wafer 16 define a quadrangle 41. As with the defined triangle 35 shown in FIG. 3, the center point 40 of wafer 16 is obtained from the intersection of mean perpendiculars 42 of sides 43 of quadrangle 41 thus defined.

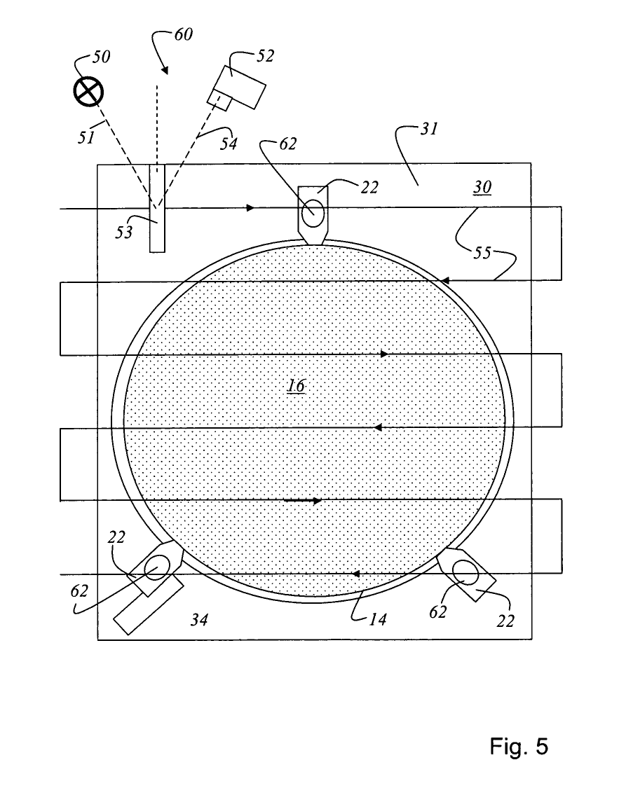

FIG. 5 is a schematic view of an arrangement for imaging a bright-field image and a dark-field image for determining the position of contacting elements 22, or of markings on contacting elements 22. Wafer 16 is within wafer holder 30 and is mechanically contacted by contacting elements 22. An optical detection apparatus 60 is arranged above wafer holder 30 for imaging surface 31 of wafer holder 30 and therefore all objects present on the wafer holder. Optical apparatus 60 is traversed along a meandering path 55 across surface 31 of wafer holder 30. Other arrangements for imaging surface 31 of wafer holder 30 may be provided. It is also conceivable that the surface 31 of wafer holder 30 and therefore of the wafer, may be imaged in one pass. To achieve this, the arrangement for optical imaging is traversed at least once across wafer or wafer holder 30 in order to generate an image of the wafer and the wafer holder. The arrangement for optical imaging of surface 31 of wafer holder 30 comprises a light source 50 which emits a light beam 51. An illuminated field 53 is formed on the surface of wafer holder 30 for corresponding movement according to the relative movement between wafer holder 30 and imaging apparatus 60 along meandering path 55 across surface 31 of wafer holder 30. Light 54 emitted by surface 31 of wafer holder 30 passes to a camera 52 which records an image of each illuminated spot 53. The images of each illuminated spot 53 are combined into an overall image of wafer holder 30. As a result, in the overall image of wafer holder 30, contacting elements 22, or contacting elements 22 provided with corresponding markings 62, are also present. The position of contacting elements 22, or markings 62, is then calculated from the recorded image. Since the distance of contacting elements 22 or their markings 62 from edge 14 of wafer 16 is known, this can be used to calculate the distance of markings 62 to the center point of wafer 16.

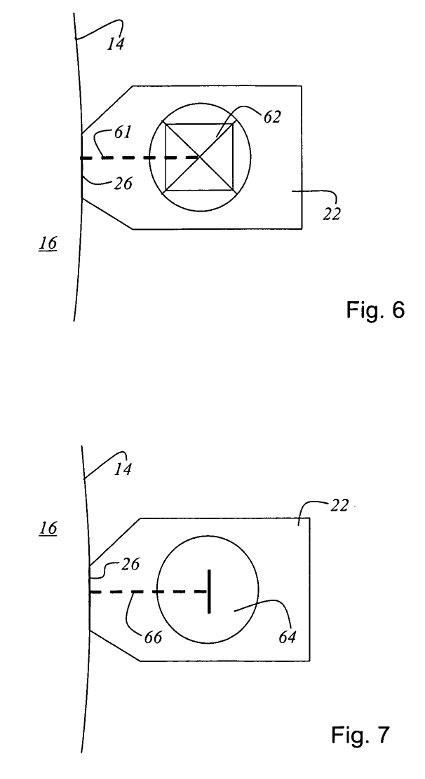

FIG. 6 is a plan view of a contacting element 22 provided with a marking 62. Contacting element 22, via a contacting surface 26 is in mechanical contact with edge 14 of wafer 16. A distance 61 from a marking element of contacting element 22 to edge 14 of wafer 16 may then be precisely determined from the determination of marking 62. This is how a defined edge determination of edge 14 of wafer 16 is obtained.

FIG. 7 shows another embodiment in a plan view of contacting element 22, wherein contacting element 22 is provided with a bore 64. Bore 64 is optically detected by means of the arrangement described with reference to FIG. 5. As a result, the distance of bore 64 to edge 14 of wafer 16 may also be precisely determined, since contacting surface 26 of contacting element 22 contacts edge 14 of wafer 16. This also allows a precise distance 66 from bore 64 to edge 14 of wafer 16 to be determined.

The invention has been described with reference to particular embodiments. It is obvious to a person skilled in the art that modifications and variations of the invention may be made without departing from the scope of protection of the appended claims.

What is claimed is

1. A method of determining geometric parameters of a wafer, comprising the steps of:
inserting the wafer in a wafer holder;
pressing an edge of the wafer against at least three mechanical contacting elements, wherein the at least three contacting elements are distributed in such a manner that a center point of the wafer is within a geometric form defined by the contacting elements;
determining each position of each contacting element, and
calculating the geometric parameters of the wafer from the positions of the contacting elements.

2. The method according to claim 1, wherein the geometric parameters are the center point or the radius, or the diameter or the roundness of the wafer.

3. The method according to claim 1, wherein each of the contacting elements is formed as a pin equipped with a marking or a bore, wherein the position of each contacting element is determined through the marking from a bright-field or dark-field image.

4. The method according to claim 1 wherein at least one of the contacting elements is equipped with a position encoder for determining the position of the contacting element.

5. The method according to claim 1, wherein at least one mechanical sensor is provided in addition to the at least three contacting elements for determining the roundness of the wafer.

6. The method according to claim 5, wherein the edge of the wafer is mechanically contacted by three contacting elements.

7. The method according to claim 6, wherein at least one of the three contacting elements is configured to be moveable, so that it allows the edge of the wafer to be pressed into contact with the other contacting elements.

8. The method according to claim 6, wherein the three contacting elements are distributed around the edge of the wafer in such a way that a center point of the wafer comes to lie within a triangle defined by the contacting elements.

9. The method according to claim 6, wherein the center point of the wafer is determined by the intersection of mean perpendiculars of a triangle defined by the three positions of the contacting elements.

10. The method according to claim 1, wherein the contacting elements have a defined distance to the edge of the wafer and therefore also have a defined distance to the center point of the wafer through the mechanical contact on the edge of the wafer and therefore the markings provided on the contacting elements.

11. The method according to claim 10, wherein a distance vector is defined by the defined distance to the edge of the wafer, which is set as a device-specific parameter.
